(19) United States
(12) Patent Application Publication
(10) Pub. No.: US 2026/0230995 A1
(43) Pub. Date: Aug. 6, 2026

(54) ON DEMAND SYSTEM INFORMATION ACQUISITION

(71) Applicant: InterDigital Patent Holdings, Inc., Wilmington, DE (US)

(72) Inventors: Brian Martin, Farnham (GB); Martino M. Freda, Laval (CA); Keiichi Kubota, Tokyo (JP); Faris Alfarhan, Montreal (CA); Ghyslain Pelletier, Montreal (CA); Diana Pani, Montreal (CA); Tuong Duc Hoang, Montreal (CA); Francois Periard, Montreal (CA); Pascal Adjakple, Great Neck, NY (US); Samuli Turtinen, Ii (FI); Paul Marinier, Brossard (CA)

(73) Assignee: InterDigital Patent Holdings, Inc., Wilmington, DE (US)

(21) Appl. No.: 19/047,145

(22) Filed: Feb. 6, 2025

(51) Int. Cl. H04W 48/02; H04W 52/02; H04W 74/0833

(52) U.S. Cl. CPC H04W 48/02; H04W 52/0235; H04W 74/0833

(57) ABSTRACT

Systems, methods, and instrumentalities are described for on demand system information acquisition. In examples, a wireless transmit/receive unit (WTRU) may be configured to determine an access type based on one of more of a capability associated with the WTRU, a network configuration, or an access attempt stage. The WTRU may select a network node (e.g., for camping) based on broadcast information associated with the network node. The WTRU may receive, from the network node, a first system information that indicates an uplink wake-up signal configuration, a supported access type of the network node, and a system information block (SIB) location. The WTRU may transmit, to the network node, an uplink request based on the uplink wake-up signal configuration. The WTRU may determine, based on the selected access type, a resource to monitor for receiving the SIB.

### BACKGROUND

Mobile communications using wireless communication continue to evolve. A fifth generation may be referred to as 5G. A sixth generation may be referred to as 6G. A previous (legacy) generation of mobile communication may be, for example, fourth generation (4G) long term evolution (LTE).

### SUMMARY

Systems, methods, and instrumentalities are described that may be associated with on demand system information acquisition. A wireless transmit/receive unit (WTRU) may include one or more of the following: a processor, a memory, or a transceiver (e.g., a transmitter and/or receiver). A WTRU may be configured to perform one or more of the following. The WTRU may determine an access type based on one or more of a capability associated with the WTRU, a network configuration, or an access attempt stage. The WTRU may select a network node (e.g., for camping) based on broadcast information associated with the network node. The WTRU may receive, from the network node, a first system information that indicates an uplink wake-up signal configuration, a supported access type of the network node, and a system information block (SIB) location. The WTRU may transmit, to the network node, an uplink request based on the uplink wake-up signal configuration. The uplink request may include an indication of a selected access type. The selected access type may be selected based on the first system information. The WTRU may determine, based on the selected access type, a resource to monitor for receiving the SIB.

The WTRU may receive, from the network node, a second system information corresponding to the selected access type. The second system information may include the SIB. The SIB may include parameters for accessing the network node. The WTRU may apply the second system information to the WTRU for a RACH procedure. The RACH procedure may be associated with connecting to the network node. The first system information may be received in a master information block (MIB) broadcast via a synchronization signal block (SSB). The first system information may include an indication that indicates whether a second system information is actively transmitted. The WTRU may select the selected access type. The selected access type may be selected based further on the capability associated with the WTRU. The access attempt stage may include a first access attempt or a subsequent access attempt.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example SSB time-frequency structure.

FIG. 3 illustrates example SS bursts and beam sweeping.

FIG. 4 illustrates an example of system information acquisition.

FIG. 5 illustrates features associated with examples described herein, where one or more of the features may be performed.

FIG. 6 illustrates features associated with examples described herein, where one or more of the features may be performed.

FIG. 7 illustrates features associated with examples described herein, where one or more of the features may be performed.

### DETAILED DESCRIPTION

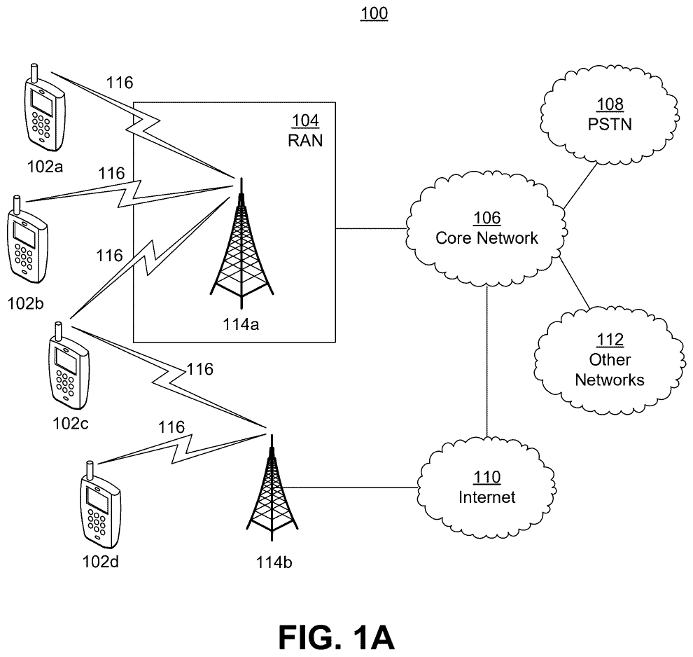

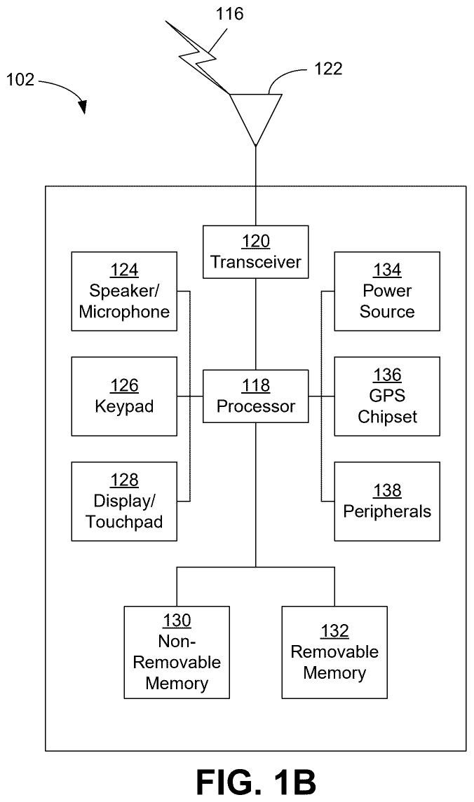

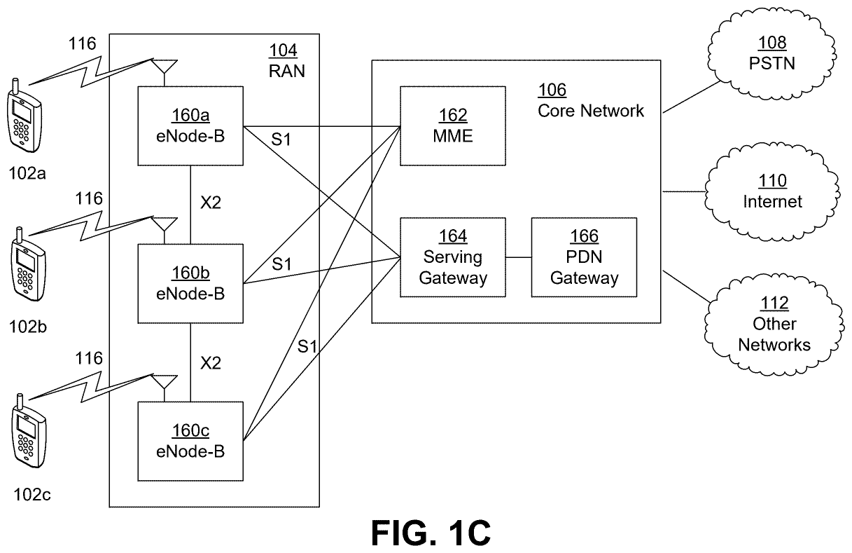

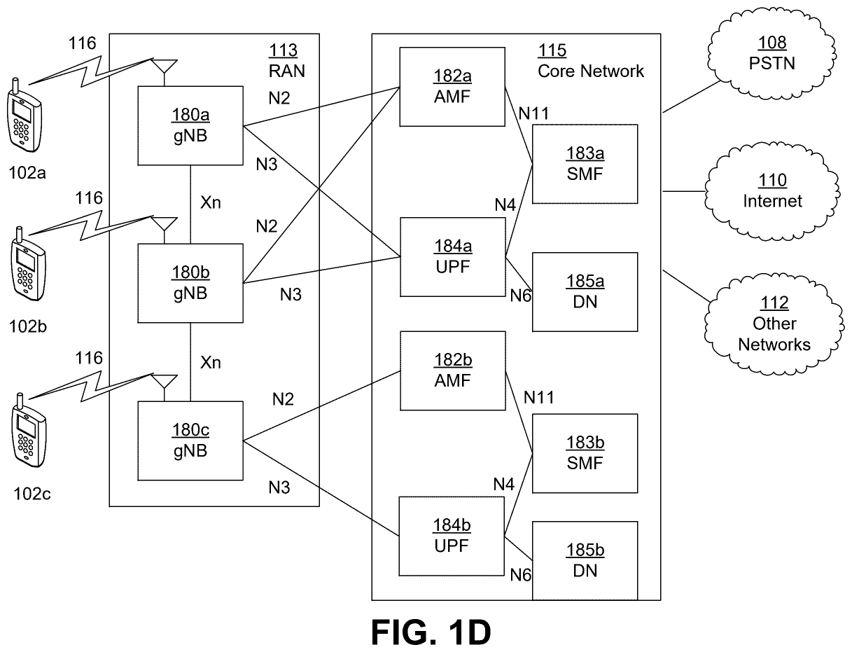

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In examples, a network may broadcast information (e.g., bare minimum information) for a WTRU to transmit an uplink wake-up/request for on demand SI and what types of access are supported in the cell. The WTRU may transmit an uplink request using the minimum configuration and include an ID to indicate the type of access the WTRU is requesting (e.g., similar to an NES wake-up signal and request for an on-demand SI). The WTRU may determine a configuration of how to receive the access type specific system information (e.g., access type specific SIB1). The WTRU may receive SIB1 and other SIBs based on the determination. SIB1 may depend on the type of access.

Features described herein may include system information acquisition. Synchronization Signals may be described herein.

The primary synchronization signal (PSS) and secondary synchronization signal (SSS) may be used in order that the WTRU can find the frame boundary and determine the physical cell identity. PSS may include one of three 127-symbols m-sequences and may be allocated on the first symbol of each SSB, and on 127 subcarriers. SSS may include one of 336 127-symbols gold sequences and may be allocated on the third symbol of an SSB and on 127 subcarriers. A cell may be identified by a physical cell ID from 1008 IDs that are arranged into 336 different groups and is calculated by

$${N}_{ID}^{cell} = 3 {N}_{ID}^{( 1 )} + {N}_{ID}^{( 2 )}$$

where:
N (1) ID=cell ID group indicated by the SSS. Range may include {0, 1 . . . 335}.
N (2) ID=cell ID sector indicated by the Primary Synchronization Signal (PSS). Range may include {0, 1, 2}.

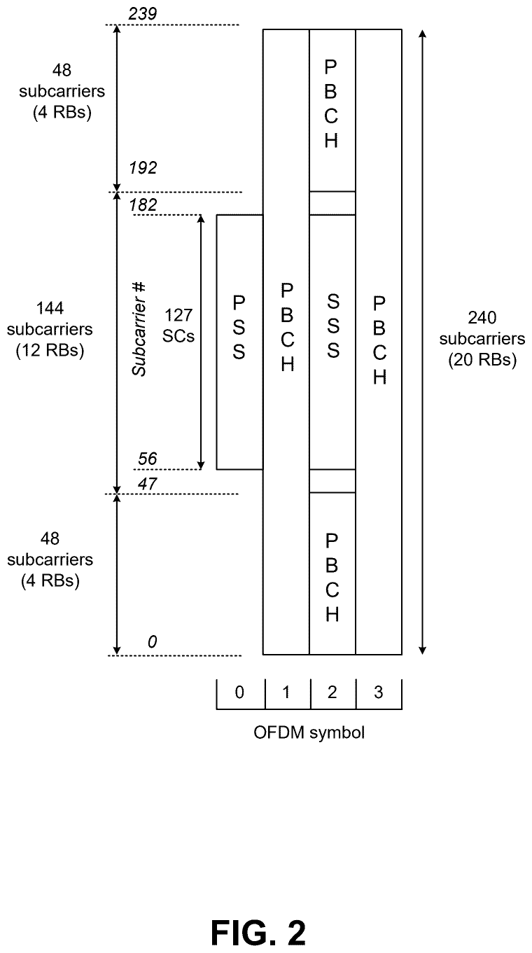

A synchronization signal block (SSB) may be described herein. FIG. 2 illustrates an example SSB time-frequency structure. The SSB may span 4 symbols in the time domain and 240 contiguous subcarriers (20 RBs) in the frequency domain. As the SSB occupies 20 RBs, and there are 12 subcarriers in an RB, there may be a total of 240 subcarriers. The bandwidth occupied by SSB=240*subcarrier spacing. 15 KHz SCS may lead to 240*15 KHz=3.6 MHz and 30 kHz SCS may lead to 240*30 KHz=7.2 MHz and so on. (e.g., a higher SCS may be FR2).

The PSS/SSS may occupy 12 RBs including the unused subcarriers above and below (e.g., PSS and SSS may use 127 subcarriers, and there may be 8 unused subcarriers below and 9 unused subcarriers above). For 15 kHz SCS the total bandwidth occupied by the PSS/SS may include 144*15=2.16 MHz, and for 30 KHz SCS, the total bandwidth may include 144*30=4.32 MHz.

The SSB structure may be associated with NR numerologies, and for a half frame with SS/PBCH blocks, the first symbol indexes for candidate SS/PBCH blocks may be determined.

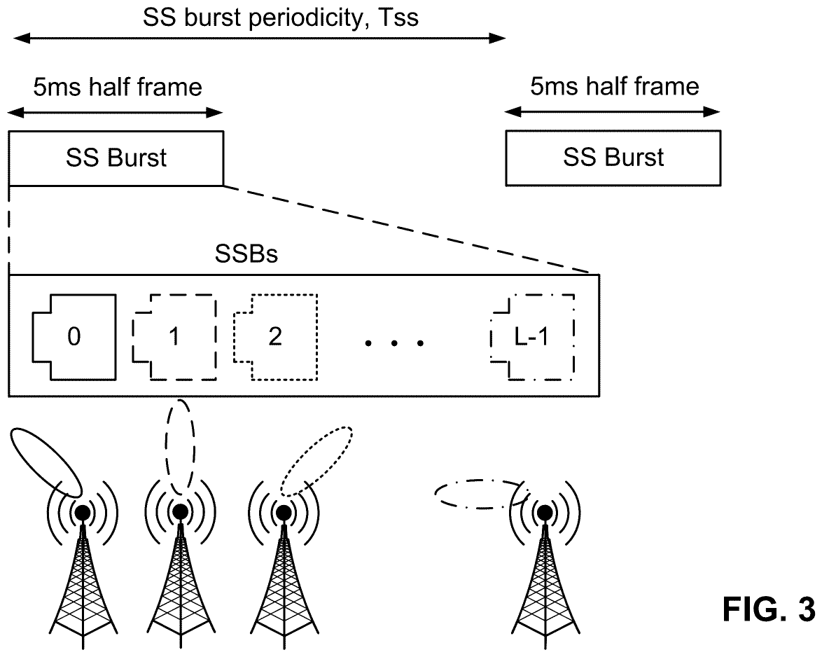

FIG. 3 illustrates example SS bursts and beam sweeping. As illustrated in FIG. 3, using beam sweeping, the gNB may periodically transmit SS bursts which include the multiple SSBs according to the SS block patterns described herein. An SSB may be transmitted using a beam using a predefined beam direction and periodicity. An SSB may be transmitted with a periodicity of 5 ms, 10 ms, 20 ms, 40 ms, 80 ms or 160 ms, and the WTRU may assume 20 ms for an initial cell search and idle mode mobility.

PBCH may broadcast the master information block (MIB). The PBCH may include information associated with identifying the candidate SSB within the SS burst-after determining the Cell ID from PSS/SSS, the WTRU may determine the 2 or 3 LSBs of the SSB index with a half-frame from the index of the DMRS transmitted in PBCH. The MSBs may be determined from the MIB contents. The MIB may indicate whether the SSB resides in the first or the second 5 ms half-frame of a 10 ms frame. After decoding PBCH, the WTRU may know the sample timing within the full frame.

The WTRU may determine the SFN from PBCH content. The WTRU may obtaining the 4 LSBs used in channel coding of the MIB by blind decode trials. A combination may correspond to a set of 4 LSBs. A trial may result in a successful decode. The 6 MSBs may be provided in the decoded MIB. After decoding the PBCH, the WTRU may know the full SFN.

The PBCH DMRS and the SSS may be used to perform channel estimation and to determine the RSRP of the candidate SSB. Based on the beam measurement, the WTRU may determine and select the best candidate beam.

The MIB may include the PDCCH configuration which may include the CORESET0 and search space 0 configuration, in order that the WTRU can receive SIB1 and the remaining system information, which may include the remaining information the WTRU needs in order to access the cell, for example the random-access channel configuration.

Table 1 may summarize information provided by PBCH.

TABLE 1
PBCH/MIB contents

| | Number of Bits | | | |
|---|---|---|---|---|
| | | | | Carried by |
| | | | | PBCH |
| | | | | (excluding |
| | | | Carried | MIB |
| Information/field | Total | | by MIB | contents) |
| System Frame Number | 10 | | 6 | 4 |
| (SFN) | | | | |
| Sub Carrier Spacing (for | 1 | | 1 | 0 |
| SIB1, Initial access Msg- | | | | |
| 2/4, paging, SI-messages) | | | | |
| SSB Subcarrier Offset | FR1 | _ 5 | 4 | 1 |
| | FR2 | _ 4 | | 0 |
| dmrs-TypeA-Position | 1 | | 1 | 0 |
| PDCCH Config for SIB1 | 8 | | 8 | 0 |
| Cell Barring Information | 1 | | 1 | 0 |
| flag | | | | |
| Intra-Frequency | 1 | | 1 | 0 |
| Reselection allowed/not | | | | |
| allowed flag | | | | |
| SSB Index | FR1 | _ 0 | 0 | |
| | FR2 | _ .3 | 3* | |
| half-frame bit | 1 | | 0 | 1 |
| Spare bits | 1 | | 1 | 0 |
| Reserved bits | FR1 | _ 2 | 0 | 2 |
| | FR2 | _ 0 | | 0 |

| | | | |
|---|---|---|---|
| BCCH-BCH-MessageType | 1 | 1 | 0 |
| indication | | | |
| CRC bits | 24 | 0 | 24 |
| Total Number of bits | 56 | 24 | 32 |
| | (FR1 or FR2) | | (FR1 or FR2) |

*4 additional (LSB) bits are implicitly carried by PBCH scrambling sequence.

Examples described herein may include a cell search. During the initial cell search, the WTRU may scan the frequency band using the sync raster according to the frequency band in which the search is being performed. The subcarrier spacing and sync raster may be based on the frequency band. The synchronization raster may indicate the frequency positions of the SSBs that can be used by the WTRU for system acquisition.

Applying synchronization algorithms using the PSS and SSS, the WTRU may estimate and correct the time and frequency offsets. The WTRU may obtain N (2) ID from PSS and then N (1) ID from SSS to determine the cell ID. With the cell ID, the WTRU may perform a PBCH DMRS search in order to perform channel and noise estimation, demodulate, and decode the PBCH to extract the remaining information for processing to PDCCH monitoring for SIB1 reception. Once the WTRU has received SIB1, the WTRU may have the common channel configurations associated with accessing the cell and may proceed with a random-access transmission in order to request on-demand system information or to establish an RRC connection in order to register and/or initiate a call.

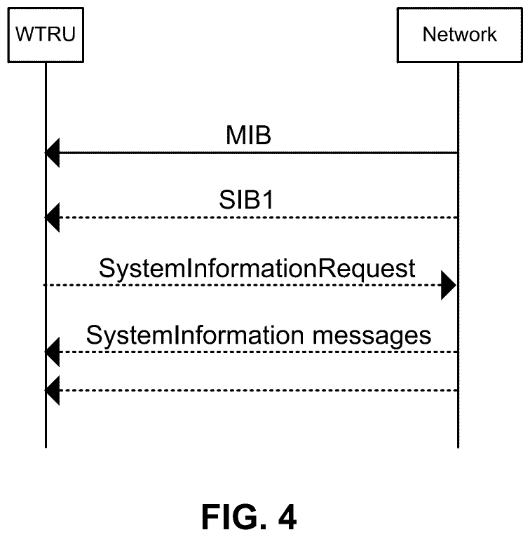

FIG. 4 illustrates an example of system information acquisition. Features described herein may be associated with system information handling. The WTRU may apply the SI acquisition procedure to acquire the AS, NAS-, and positioning assistance data information. Examples described herein may apply to WTRUs in RRC_IDLE, in RRC_INACTIVE, and in RRC_CONNECTED.

System Information (SI) may include an MIB and a number of SIBs, which are divided into a minimum SI and other SI (e.g., non-minimum Sls).

Minimum SI may include information associated with initial access and information for acquiring an SI. minimum SI may include the following. MIB may include cell barred status information and physical layer information of the cell required to receive further system information, e.g., CORESET #0 configuration. MIB may be periodically broadcasted on BCH.

Minimum SI may include the following. SIB1 may include scheduling of system information blocks and include information associated with initial access. SIB1 may be referred to as remaining minimum SI (RMSI) and may be periodically broadcast on DL-SCH or sent in a dedicated manner on DL-SCH to WTRUs in RRC_CONNECTED.

Other SI may include (e.g., all) SIBs not broadcasted in the minimum SI. The SIBs may be periodically broadcasted on DL-SCH, broadcasted on-demand on DL-SCH, or sent in a dedicated manner on DL-SCH to WTRUs in RRC_CONNECTED.

The MIB may be mapped on the BCCH and carried on BCH. SI messages may be mapped on the BCCH, where they are dynamically carried on DL-SCH. The scheduling of SI messages part of other SI may be indicated by SIB1.

For WTRUs in RRC_IDLE and RRC_INACTIVE, a request for other SI may trigger a random access procedure where MSG3 includes the SI request message unless the requested SI is associated to a subset of the PRACH resources (e.g., in which case MSG1 is used for indication of the requested other SI). When MSG1 is used, the minimum granularity of the request may be one SI message (e.g., a set of SIBs), one RACH preamble, and/or PRACH resource may be used to request multiple SI messages. The gNB may acknowledge the request in MSG2. When MSG 3 is used, the gNB may acknowledge the request in MSG4.

The other SI may be broadcasted at a configurable periodicity and for a certain duration. The other SI may also be broadcasted when it is requested by the WTRU in RRC_IDLE/RRC_INACTIVE/RRC_CONNECTED.

For a WTRU to be allowed to camp on a cell, the WTRU must have acquired the contents of the minimum SI from that cell. There may be cells in the system that do not broadcast the minimum SI and where the WTRU therefore cannot camp.

Change of system information (e.g., except ETWS/CMAS) may occur at specific radio frames, e.g., the concept of a modification period may be used. System information may be transmitted a number of times with the same content within a modification period, as described by its scheduling. The modification period may be configured by system information. When the network changes system information, the network may notify the WTRUs about the change, e.g., this may be done throughout a modification period. In the next modification period, the network may transmit the updated system information. Upon receiving a change notification, the WTRU may acquire the updated system information from the start of the next modification period. The WTRU may apply the previously acquired system information until the WTRU acquires the new system information.

Features described herein may be associated with reduced capability (RedCap). RedCap may be associated with one or more of the following: a reduction in WTRU complexity through fewer RX/TX antennas, reduced WTRU use of bandwidth, lower WTRU power consumption, relaxed data rates, or relaxed WTRU processing time and processing capability.

The RF bandwidth of devices may support a maximum of 5 MHz (e.g., instead of a minimum bandwidth of 20 MHz). For some bands and subcarrier spacing configurations, the SSB including the MIB itself may exceed 5 MHz. There were also not enough spare bits to extend MIB to indicate a separate SIB1 scheduled on a narrower bandwidth.

A limit may be set on the amount of PDSCH resources that could be scheduled to a reduced capability device, such that data scheduling may be limited to 5 MHz. The WTRU may be capable of receiving control information over 20 MHz. The MIB and SIB1 may be used, and in SIB1, an updated RedCap specific initial BWP may be configured. The Redcap Device may use a reduced bandwidth for PDSCH after receiving SIB1 and the RedCap initial BWP configuration.

Features described herein may be associated with network energy saving and SIB1-less cell operation. Devices may operate without SSB/SIB1 for intra-band carrier aggregation. A device may gather system information and achieve synchronization through another cell within the same band that does transmit SSB and SIB1. In examples, the SSB periodicity may be up to 160 milliseconds. In non-carrier aggregation and in IDLE/INACTIVE states, SIB1-less operation may allow a device to collect system information and achieve synchronization by using signals from other associated cells. This may allow the network to apply longer durations of cell dormancy to help save network energy. The transmission of SSB/SIB1 in the primary cell may be initiated, for instance, by a request from the device. In examples, NW energy savings may be associated with enabling such SIB1-less operation and allow the WTRU to request on demand SIB1 (e.g., when needed) network transmissions of always-on signals when there is no data. Signals and channels may be transmitted/received at fixed periodicities, which may consume energy at the network, for example, when not transmitting for other activities (e.g., baseband digital beamforming processing). Such idle power consumption may occur in dense networks, e.g., during low cell load conditions. Network energy consumption may be reduced when the network does not exchange transmissions with the WTRU. Depending on cell load, periodicities may be adapted at which SSBs, SIBs (e.g., SIB1), RACH, and paging channels are transmitted/received.

Features described herein may be associated with targeting connected mode and low load scenarios and avoiding impacts on the IDLE/INACTIVE. Examples may include reducing the network energy consumption associated with the transmission of user specific signals and channels. NES gains from cell DTX/DRX operation may be limited, as the gNB may be ready for the transmission of common signals/channels, such as periodic SSB, SIB1 etc., and RACH reception. Energy savings may be possible by considering NES techniques when supporting WTRUs operating in RRC idle/inactive states.

SIB1 may be broadcast with SSB. SIB1 information may be associated with idle/inactive WTRUs as it provides the information to camp on a cell or provides information on how to obtain additional system information. From an energy saving perspective, the network may choose a cell to transmit reduced periodicity SIB1 transmissions or completely stop transmitting SIB1 at all. Idle or inactive mode WTRUs in the cells may request on-demand SIB1 transmission.

To target energy savings by reduced transmission of SIB1 or with SIB1 turned off, network deployments may be considered. The network deployments may be based on micro or capacity cells overlaid over macro cells, cells deployments over different carrier frequencies and/or different bands, cells operating in FR1/FR2, etc. For the implementations and procedural updates for the feature of on-demand SIB1, the following example deployments may be considered: standalone NES cell deployments and multi-cell deployments with NES cell(s) operating with at least one anchor cell.

In the standalone NES deployments, WTRUs in idle/inactive mode may receive SSBs from the NES cell that they intend to camp on. The NES cell may not be broadcasting the SIB1 according to the legacy SSB/SIB1 transmission periodicities. In examples, the NES cells may broadcast SIB1 with reduced transmission periodicity. In examples, NES cells may not be transmitting SIB1. The WTRUs may (e.g., may need to) receive SIB1 to be able to camp on the cell. The WTRUs may detect the cell being in NES mode and transmit a request for on-demand transmission of SIB1. WTRUs may have a valid UL WUS configuration through which on-demand SIB1 request can be initiated.

In multi-cell deployment, the idle/inactive WTRUs may be in coverage of at least one anchor cell and one or more NES cells. The NES cells may be transitioned to sleep mode with no SIB1 transmission during no/low load conditions. The functionalities related to camping and initial access for the idle/inactive WTRUs may be supported with assistance from the anchor cell, which may continue to transmit/receive the common signals/channels, including SSB/SIB1. In anchor cell-based examples, the WTRUs may obtain the configuration for UL WUS from the anchor cell.

Features described herein may be associated with incorporation of sensing and AIML into the RAN. In examples, a unified specification may tailor to categories of WTRUs and verticals. For example, network energy saving may be considered such that network energy consumption is improved, such as being able to switch off SIB1 transmission and being able to switch off (e.g., some of) the broadcast reference signals.

Broadcast of system information may result in resource overhead and network power consumption (e.g., due to a large number of features). A larger SIB1 size may limit coverage in some deployments due to using higher MCS or more repetitions due to more information being transmitted

Features described herein may be associated with an on-demand SI. SIB1 overhead may be large because of basic device access involving a significant number of parameters for different types of WTRUs and allowing flexibility for configuration.

Features described herein may be associated with scalability to updated features and support of LPWA introduces complexity and backward compatibility (e.g., because an access/bandwidth may be for smartphone devices rather than other use cases (e.g., wearables, NB-IOT, etc.).

RedCap may introduces reduced capability compared to, for example, a baseline. Supporting reduced capability devices may be associated with patches and updated features, which may increase SIB overhead and overall complexity. SIB1 may be transmitted in NR to enable receiving the (e.g., necessary) information to camp, resulting in increased network energy consumption and resource overhead.

Features described herein may be associated with SIB1-less cell operation. A neighbor cell may provide a wake-up uplink configuration (e.g., so that WTRUs can request SIB1). Neighbor cell signaling may be used, so not all cells may use SIB1-less at the same time, for example.

System information may be configured to minimize broadcast overhead, support for low capability devices from the outset, while enabling network energy savings. The network may broadcast information (e.g., minimum information) for the WTRU to transmit an uplink wake-up/request for on demand SI. The information may include and/or indicate types of access that are supported in the cell (e.g., in some examples the information is limited to indicating type(s) of access that are supported in the cell).

The WTRU may transmit an uplink request using the minimum configuration (e.g., as indicated by and/or based on the broadcast information) and may include an ID to indicate the type of access the WTRU is requesting (e.g., similar to an NES wake-up signal, and the request for on-demand SI).

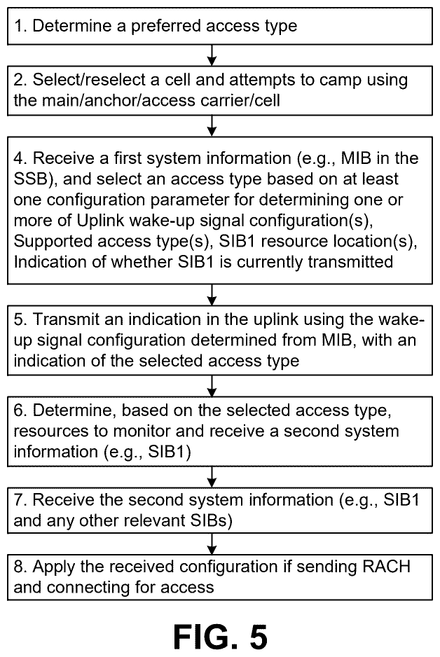

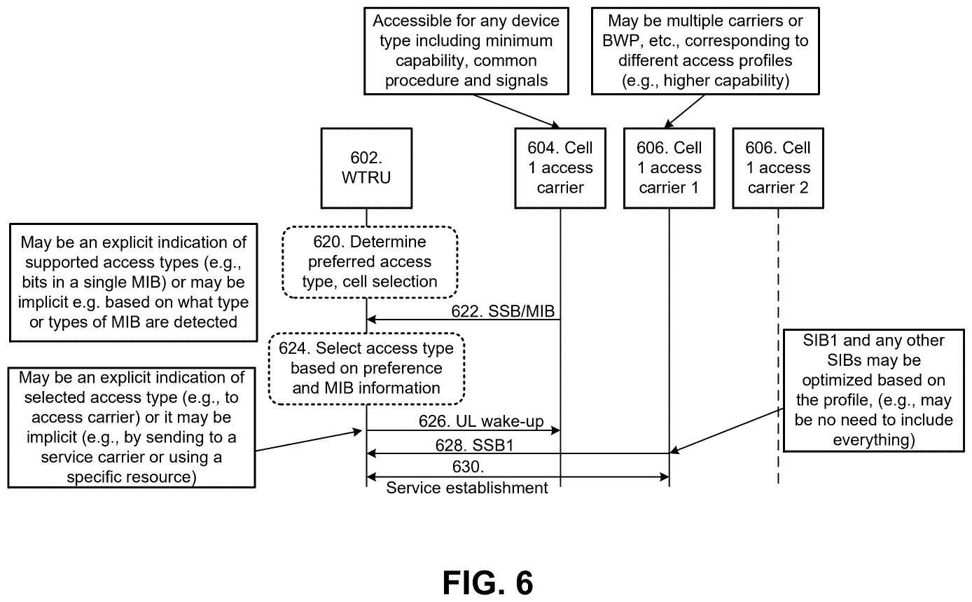

FIG. 5 illustrates features associated with examples described herein, where one or more of the features may be performed. FIG. 6 illustrates features associated with examples described herein, where one or more of the features may be performed. A WTRU 602 may determine a configuration to use for receiving access type specific system information (e.g. access type specific SIB1). The WTRU 602 may receive SIB1 and relevant SIBs based on the determination. SIB1 may be configured depending on the type of access.

At 620, for example, the WTRU 602 may determine an access type (e.g., a preferred access type) based on at least one or more of the following: a capability (e.g., a capability associated with the WTRU 602), such as, for example a minimum capability (e.g., RedCap/narrowband), eMBB, URLLC, etc.; a configuration (e.g., a NW assigned access type to the WTRU 602 (e.g., after first attach/connection)); or an access attempt stage (e.g., a first access attempt versus a subsequent access attempt, where minimum capability may be sufficient for attach (e.g., initial attach) signaling, and subsequent accesses may use eMBB access for service. A same (e.g., identical) initial attach procedure may be used for devices if the devices use the minimum capability access type).

The WTRU 602 may select or reselect a cell (e.g., a network node, for example, to camp on) and attempt to camp using the main/anchor/access carrier/cell (e.g., 604). In examples, in an example multicarrier cell deployment, a carrier (e.g., one carrier (e.g., 604)) may be used for access (e.g., similar to NB-IoT anchor). Carrier(s) (e.g., other carrier(s) 606) may provide specific services/capabilities.

At 622, for example, the WTRU 602 may receive a first system information (e.g. a MIB in the SSB), and select an access type based on receiving at least one configuration parameter. The configuration parameter may be used for determining one or more of the following: an uplink wake-up signal configuration, such as an index to one or more predetermined configurations (e.g. a table in a standard); a supported access type(s) in the cell, which may enable the WTRU 602 to select an access type based on capability (e.g., at 624, the WTRU 602 may select the best access type it supports, for example, if the WTRU 602 prefers a high capability access type, and the NW enables minimum capability, the WTRU 602 may select the closest to preferred access type, which may be the highest access type the NW supports); second system information (e.g., SIB1) resource location(s), where different carriers or cells may be used for different access types with different bandwidths, numerology, etc.; or an indication of whether the one or more second system information is currently being transmitted.

At 626, the WTRU 602 may transmit an indication in the uplink using the wake-up signal configuration determined from the first system information. The transmission may include an indication of the selected access type (e.g., unless it has been determined the relevant SIB1 is already being broadcast).

The WTRU 602 may determine, based on the selected access type, resource(s) to monitor and receive SIB1. At 628, the WTRU 602 may receive an SIB1 and check if relevant information is present. If not, the WTRU 602 may send a request for missing information. Resources may include, e.g., carrier location, resources configuration, BWP, etc.

The WTRU 602 may receive the second system information (e.g., the second system information may include SIB1) and may receive relevant SIBs (e.g., SIB2, SIB3, etc.), which may include parameters for accessing the network node. At 630, the WTRU 602 may apply the received configuration (e.g., the received configuration in the second system information) when sending a RACH transmission (e.g., a RACH associated with connecting to the network node/service establishment) and connecting for network access.

Examples described herein may enable SIB1-less operation without requiring the wake-up configuration information to be provided by a neighbor cell (e.g., it may be determined from MIB). Examples described herein may minimize the always broadcast information to the MIB. SIB1 may be provided on demand, allowing SIB1 to be associated with an access type (e.g., instead of containing all information for all WTRUs), which may be associated with minimizing overhead. The selected access type may be determined by respective SIBs. Examples described herein may enable low complexity devices to use the same access mechanism as higher capability devices.

A synchronization signal block (SSB) or SS/PBCH block may include at least one or more of the following: primary synchronization signal (PSS), secondary synchronization signal (SSS), physical broadcast channel (PBCH) (e.g., data, MIB) and PBCH (DMRS). The SSBs may be transmitted by the NW node (e.g., base station, TRP, relay node, RIS unit) in directions as beams. The number of SSB beams in an SSB burst set, which may be transmitted periodically within an interval (e.g., 5 ms), may depend on the carrier frequency. For example, an SSB burst may include 4 SSBs for FR1 (e.g., <3 GHZ), 8 SSBs for FR1 (3 to 6 GHZ), and 64 SSBs for FR2. SSBs may be transmitted as on-demand SSBs (OD-SSBs), which may include a subset of SSBs in a burst. OD-SSBs may be transmitted aperiodically, semi-persistently, or periodically with a (e.g., a certain) periodicity. The transmission of OD-SSBs may be triggered by the NW node or WTRU (e.g., via transmission of an UL WUS). Some SSBs may include slim/lean SSBs, which may include PSS (e.g., PSS only), PSS and SSS (e.g., SSS only), PBCH, or a subset of MIB (e.g., MIB-only), for example. An SSB may include updated reference signals and may be transmitted in a manner which allows low capability devices to receive, for example, on a narrow bandwidth.

A system information block (SIB) may include information which is broadcast by the network, always or upon request, to enable devices to perform steps (e.g., first steps) associated with initial access. System information may include information related to uplink resources (e.g., RACH), and may include additional information, for example, neighbor cell information enabling the WTRU to perform mobility between cells in an idle state, check whether access to cells are allowed, receive information related to emergency notification systems, such as ETWS or CMAS, and information which may be used by WTRUs in an idle state or when connecting to the cell. The system information may include a master information block (MIB), minimum system information (SIB1), and system information (e.g., other system information) (SIB2 through SIB25). Minimum information may be used for the first uplink communication broadcast in a first block similar to MIB. A second block of information similar to SIB1 may be included to provide information associated with parameters (e.g., pertinent parameters) that are associated with connecting with the cell.

A channel state information reference signal (CSI-RS) may include at least one of the following: CSI-RS resource set (ID), CSI-RS resource (ID/index), resource mapping, power control offset values (e.g., with respect to PDSCH, SSB), scrambling ID, periodicity, offset, or QCL info. The CSI-RS may be transmitted in DL by the NW node as CSI-RS beams, via resource types including periodic, semi-persistent and aperiodic. The CSI-RS may be transmitted upon request (e.g., on demand) to support measurements and beam management for connected devices and may be transmitted using a new signal design.

Channel conditions may include conditions relating to the state of the radio/channel, which may be determined by the WTRU from: a WTRU measurement (e.g., L1/SINR/RSRP, CQI/MCS, channel occupancy, RSSI, power headroom, exposure headroom), L3/mobility-based measurements (e.g., RSRP, RSRQ, s-measure), an RLM state, or channel availability in unlicensed spectrum (e.g., whether the channel is occupied based on determination of an LBT procedure or whether the channel is deemed to have experienced a consistent LBT failure). The network may determine uplink channel conditions using a reference signal transmitted by the device.

Features described herein may be associated with radio access technology (RAT). Terms, channels, and protocol design for NR may be used. Configurations may include an upper (e.g., RRC) layer, which may apply to multiple target cells, beam, or TRPs and the lower layer (e.g., MAC, L1) controls switching between the configurations. In examples, all or part of the configuration may come from lower layers (e.g., MAC), for example in case different network nodes are responsible for providing their own configuration, such as a DU providing a L2 configuration and a CU providing a L3 configuration, which may use its own signaling procedures and design. In examples, the radio nodes of the network may be split into a centralized unit (CU), distributed unit (DU) and radio unit (RU). A CU may control one or more DUs, and a DU may control one or more RUs. In examples, the DU configuration may be provided to the CU and transmitted to the WTRU from the CU using RRC signaling. In examples, the DU may provide its configuration directly to the WTRU using L2 signaling.

Features described herein may be associated with enabling devices to access cells in a manner that allows minimum broadcast overhead to reduce network energy consumption, minimize resource overhead, and enable support of (e.g., low complexity) devices.

The first system information may be received. The WTRU may determine a cell to select or reselect, for example using RSRP measurements and a predetermined criteria. The WTRU may switches on and attempt to search for cells in order to attach/register with the network. This may occur after the WTRU first attaches or registers to the network, and may occur in an idle, connected, or semi-connected state, for example, similar to cell reselection in RRC_INACTIVE state in NR.

After the WTRU has selected a cell, for example, the WTRU may receive a first system information. The first system information may include the following. The first system information may include an MIB included in an SSB. An MIB may be common for (e.g., all) devices types. The first system information may include one of multiple MIBs. For example, an MIB type may be broadcast in a physical location or use a physical format to cater for a device type, capability, or access type. The first system information may include information conveyed or encoded as part of reference signals. For example, sequences may be used to indicate pre-determined configurations. For example, a first reference sequence may indicate a first access type is supported, and a second reference sequence may indicate a second access type is supported. The first system information may include an MIB transmitted separately to reference signals. For example, in an SSB redesign, the PSS and SSS (e.g., or similar synchronization signals) may indicate a location for receiving a MIB or other first system information type.

MIB may include the first piece of system information the WTRU receives, regardless of how it is encoded. As part of the first system information, the WTRU may receive an indication of one or more of the following. The WTRU may receive an indication of an uplink wake-up signal configuration(s). The uplink wake-up signal configuration may be an uplink configuration described herein.

The uplink wake-up signal configuration may be an explicit indication, for example. The uplink wake-up signal configuration may be a preamble index or resource index. The uplink wake-up signal configuration may be a pointer to one of a set of predetermined configurations, such as a pointer to a table in the standards or a pointer to a table which may be configured by the network following a first connection. The uplink wake-up signal configuration may be one or more explicit configuration parameters.

The uplink wake-up signal configuration may be implicit, for example. For a WTRU performing access for the first time, a signal configuration may be used (e.g., the network may configure one or more signal configurations to use for subsequent access). The WTRU may determine the signal to use based on the resources the system information was received with, or based on the system information type detected. The WTRU may select a configuration based on another of the parameters, for example, the supported access types—for an access type, the WTRU may use a predetermined configuration.

The WTRU may at least partially derive an uplink signal configuration based on one or more of the following characteristics of signal received in the cell, for example: PSS or SSS; numerology; bandwidth; carrier frequency; band; or physical cell identity.

The WTRU may derive an uplink signal configuration based on radio measurements. For example, if the signal is above a certain threshold, use a first configuration may be used. A second configuration may be used (e.g., if the first configuration is not used).

The WTRU may select the uplink configuration based on whether the cell indicates that it is using one or more power saving states. The WTRU may receive an indication of supported access type(s) in the cell. The WTRU may be enabled to select an access type based on capability. The supported access types may be explicit, using one or more bits of information. The supported access types may be implicit. For example, the physical format or location of the system information may be used to derive one or more supported access types. The WTRU may at least partially derive supported access types based on one or more of the following characteristics of a signal received in the cell, for example: PSS or SSS; numerology; bandwidth; carrier frequency; band; or physical cell identity.

The WTRU may receive an indication of one or more second system information (e.g., SIB1) resource location(s). For example, a cell may have (e.g., different) carriers or cells for (e.g., different) access types, e.g., with (e.g., different) bandwidth, numerology, etc. The resource location may be a pointer or reference to a particular carrier.

The second system information may use one or more of the following (e.g., different) formats depending on the access type, for example: transport block size; RRC or other message format, configured to the access type; modulation and coding scheme; number of repetitions; SIB scheduling, for example, transmitted more or less frequently; number or segments; a SIB transmitted to a low capability WTRU may be divided into more segments to enable transmission using smaller transport blocks or a narrower bandwidth; or a RNTI in order to schedule multiple SIB1 types to WTRUs using (e.g., different) access types (e.g., with the same control channel).

A cell may use downlink physical channels to convey the second system information. The transmission may include one or more of the following: different CORESET0 or similar control resource set or control channel configuration; different bandwidth part; different time or frequency resources within a carrier; different format or numerology; the resource location may be a pointer to a particular channel configuration; or different physical shared channel or common channel configuration for reception of the broadcast data.

The first system information may indicate where to find the second system information for one or more particular access types. The location of the second system information may be identified using one or more of the following: explicit bits, for example, using a numerical value to indicate one from a set of possible configurations; or, and implicit determination. For an implicit determination, the following may be true: for a WTRU performing access for the first time, a configuration may be used (e.g., the network may configure one or more signal configurations to use for subsequent access); the WTRU may determine the configuration to use based on the specific resources the first system information was received with, or based on the system information type detected; or the WTRU may select a configuration based on another of the parameters, for example, the supported access types—for a specific access type, the WTRU may use a predetermined configuration.

The first system information may provide an indication of whether the one or more second system information are currently being transmitted. The WTRU may select the uplink configuration based on whether the cell indicates that it is using one or more power saving states. The WTRU may at least partially derive the resource locations of the second system information based on the characteristics of signal received in the cell, for example: PSS or SSS; numerology; bandwidth; carrier frequency; band; or physical cell identity.

A WTRU may determine a (e.g., preferred) access type to use when receiving or requesting system information. An access type may include a way in which the WTRU will perform system information reception. A WTRU may support one or more access types, and the network may indicate support for one or more access types.

An access type may be selected based on, or correspond to, one or more of the following. The WTRU may determine an access type based on a WTRU Capability, such as one or more of the following: a maximum capability of a device (e.g., RedCap/narrowband), eMBB, URLLC, etc.; supported bands or bandwidths; number of supported carriers for carrier aggregation; maximum supported data rate; support for certain features, for example dual connectivity, XR, AIML; or support for a particular set of features.

An access type may be selected based on the type of access. For example, the WTRU may be camping on a cell, in which case a minimum performing access type may be used. The WTRU may connect to the cell, in which case a higher performing access type may be requested.

An access type may be selected based on User or service preference. For example, the device may be configured in a power saving mode. The WTRU may select a power efficient access type. The WTRU may select a higher performing access type (e.g., if the power efficient access type is not selected).

An access type may be selected based on service type, e.g., whether the WTRU is connecting to the cell for a particular type of service with certain QoS requirements, or a certain data type. Example service types may include one or more of the following: a small data transmission; video stream; voice; web based connectivity; high priority access or emergency; broadcast service; machine type communication; registration or attach; sensing data; AIML data collection; or low priority data report.

An access type may be selected based on a configuration/assignment of access type. For example, the network may assign an access type to a WTRU when it first registers on the network. The assigned access type may, for example, be based on a NAS level exchange on WTRU capabilities or services, or based on a subscription type.

The assigned access type may be based on first access vs subsequent access. For example, a minimum capability may be used to perform the registration signaling for all devices, then any subsequent access may depend on WTRU capability or a property that may be used to determine an access type.

The WTRU may select an access type based on any of the above criteria, in combination with an indication of what the network supports. For example, in the first system information, an indication of one or more supported access types may be received. The WTRU may select one or more of the supported access types indicated by the network.

The selected access type may not be the preferred access type. For example, the WTRU may prefer a high capability access type, and the network may enable a minimum capability access type. For example, the WTRU may select the minimum capability access type. The WTRU may request further information, for example, receiving the second system information, connecting using a default configuration, and receiving dedicated signaling to provide additional capabilities or resource configurations.

The WTRU may select an access type based on whether and what information the WTRU already has about the cell. For example, the WTRU may have previously accessed the cell and stored some minimum capability information about the cell. The WTRU may determine that this stored information is still valid, for example by use of value tags, and request the information which is still missing, for example, the information related to higher capabilities. One of more specific access types may be determined to make this type of request, such that the WTRU can request one or more minimum capability or maximum capability parameters.

Features described herein may include an indication of access type. The WTRU may transmit an indication in the uplink using the wake-up signal configuration determined from the first system information, with an indication of the selected access type. In examples, the WTRU may do this if the first system information indicates that the second system information corresponding to the selected access type is not currently being transmitted.

The WTRU may transmit in the uplink using a preamble configuration received from a neighbor cell. In examples, a preamble configuration may be received in the first system information. In examples, a type of uplink signal may be configured, for example, one or more uplink reference signals, such as a sounding reference signal (SRS), or similar. A low power wake-up signal may be configured by indicating a reference index to one or more predetermined configs (e.g., a table)

In general, the wake-up signal may correspond to a signal in the uplink which is transmitted by the WTRU to request the second system information. The wake-up signal may correspond to the type of second system information to be transmitted. Based on the wake-up signal and the selected access type, the cell may present itself accordingly. For example, a cell may transmit the second system information based on a low capability device if the low capability access type is selected. The cell may transmit a second system information based on a high capability device if a high capability access type is indicated.

The uplink signal may be one or more of the following: a random-access preamble; an uplink reference signal such as SRS; a dedicated physical resource, such as a shared configured grant; or a low power wake-up signal, using a power efficient modulation scheme such as OOK and/or transmitted using a power efficient radio transmitter.

The wake-up signal may be sent using the resources, channel, or carrier corresponding with the initial information received in the first system information. For example, if a cell is configured with a (e.g., one) initial/access/anchor carrier and carriers for particular services, the wake-up signal may be sent to the initial/access/anchor carrier. In examples, the wake-up signal may be sent to the carrier or resources corresponding to the selected access type.

The wake-up signal may include an indication of the requested access type. For example, the indication may include an explicit indication using a numerical value to indicate a selected access type. For example, the indication may include an explicit index using a reference to one of the list of supported access types provided in the first system information. For example, the indication may include an implicit indication, such as use of a particular reference sequence or use of a particular resource (e.g. a particular one or group of preambles, a particular time or frequency resource, or sending the wake-up to a particular carrier, such as if access types are associated with carriers).

The second system information may be received. The WTRU may acquire the second system information and relevant SIBs (SIB2, 3, etc.). The WTRU may apply the received configuration when sending RACH and connecting for access, performing cell reselection, etc.

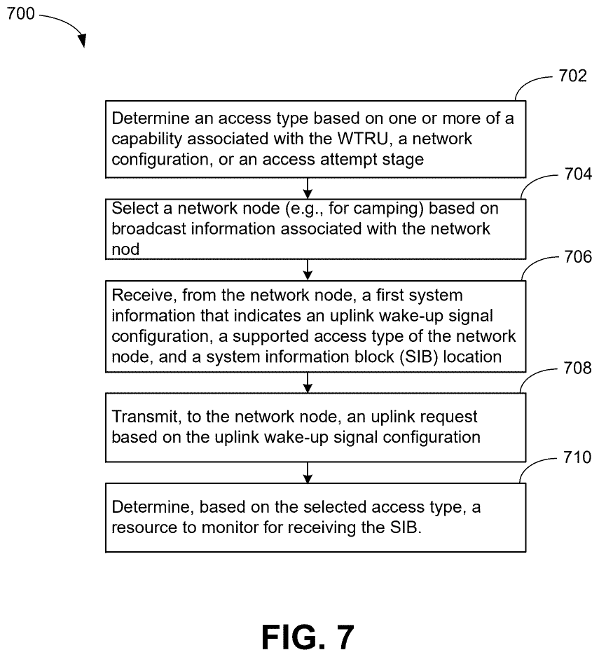

FIG. 7 illustrates an example 700 of features associated with examples described herein, where one or more of the features may be performed.

Systems, methods, and instrumentalities are described for on demand system information acquisition. For example, at 702 a wireless transmit/receive unit (WTRU) may be configured to determine an access type based on one or more of a capability associated with the WTRU, a network configuration, or an access attempt stage. At 704, the WTRU may select a network node (e.g., for camping) based on broadcast information associated with the network node. At 706, the WTRU may receive, from the network node, a first system information that indicates an uplink wake-up signal configuration, a supported access type of the network node, and a system information block (SIB) location. At 708, the WTRU may transmit, to the network node, an uplink request based on the uplink wake-up signal configuration. The uplink request may include an indication of a selected access type. The selected access type may be selected based on the first system information. At 710, the WTRU may determine, based on the selected access type, a resource to monitor for receiving the SIB.

The WTRU may receive, from the network node, a second system information corresponding to the selected access type. The second system information may include the SIB. The SIB may include parameters for accessing the network node. The WTRU may apply the second system information to the WTRU for a RACH procedure. The RACH procedure may be associated with connecting to the network node. The first system information may be received in a master information block (MIB) broadcast via a synchronization signal block (SSB). The first system information may include an indication that indicates whether a second system information is actively transmitted. The WTRU may select the selected access type. The selected access type may be selected based further on the capability associated with the WTRU. The access attempt stage may include a first access attempt or a subsequent access attempt.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although features described herein consider LTE, LTE-A, New Radio (NR) or 5G specific protocols, it is understood that the features described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random-access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU) comprising a processor, the processor configured to:
determine an access type based on one of more of a capability associated with the WTRU, a network configuration, or an access attempt stage;
select a network node (e.g., for camping) based on broadcast information associated with the network node;
receive, from the network node, a first system information that indicates an uplink wake-up signal configuration, a supported access type of the network node, and a system information block (SIB) location;
transmit, to the network node, an uplink request based on the uplink wake-up signal configuration, wherein the uplink request comprises an indication of a selected access type, and wherein the selected access type is selected based on the first system information; and
determine, based on the selected access type, a resource to monitor for receiving an SIB.

2. The WTRU of claim 1, wherein the processor is further configured to receive, from the network node, a second system information corresponding to the selected access type, wherein the second system information comprises the SIB, and wherein the SIB comprises parameters for accessing the network node.

3. The WTRU of claim 2, wherein the processor is further configured to apply the second system information to the WTRU for a random-access channel (RACH) procedure, wherein the RACH procedure is associated with connecting to the network node.

4. The WTRU of claim 1, wherein the first system information is received in a master information block (MIB) broadcast via a synchronization signal block (SSB).

5. The WTRU of claim 1, wherein the first system information further comprises an indication that indicates whether a second system information is actively transmitted.

6. The WTRU of claim 1, wherein the processor is further configured to:
select the selected access type, wherein the selected access type is selected based further on the capability associated with the WTRU.

7. The WTRU of claim 1, wherein the access attempt stage comprises a first access attempt or a subsequent access attempt.

8. A method for a wireless transmit/receive unit (WTRU), the method comprising:
determining an access type based on one of more of a capability associated with the WTRU, a network configuration, or an access attempt stage;
selecting a network node (e.g., for camping) based on broadcast information associated with the network node;
receiving, from the network node, a first system information that indicates an uplink wake-up signal configuration, a supported access type of the network node, and a system information block (SIB) location;
transmitting, to the network node, an uplink request based on the uplink wake-up signal configuration, wherein the uplink request comprises an indication of a selected access type, and wherein the selected access type is selected based on the first system information; and
determining, based on the selected access type, a resource to monitor for receiving an SIB.

9. The method of claim 8, wherein the method further comprises receiving, from the network node, a second system information corresponding to the selected access type, wherein the second system information comprises the SIB, and wherein the SIB comprises parameters for accessing the network node.

10. The method of claim 9, wherein the method further comprises applying the second system information to the WTRU for a random-access channel (RACH) procedure, wherein the RACH procedure is associated with connecting to the network node.

11. The method of claim 8, wherein the first system information is received in a master information block (MIB) broadcast via a synchronization signal block (SSB).

12. The WTRU of claim 8, wherein the first system information further comprises an indication that indicates whether a second system information is actively transmitted.

13. The method of claim 8, wherein the method further comprises selecting the selected access type, wherein the selected access type is selected based further on the capability associated with the WTRU.

14. The method of claim 8, wherein the access attempt stage comprises a first access attempt or a subsequent access attempt.
